(19) United States
(12) Patent Application Publication
(10) Pub. No.: US 2007/0098332 A1
(43) Pub. Date: May 3, 2007

(54) Package for optical components

(75) Inventors: Alex Rosiewicz, Stow, MA (US); Michio Matsuki, Andover, MA (US); Ninghui Zhu, Winchester, MA (US)

Correspondence Address: WILMER CUTLER PICKERING HALE AND DORR LLP, 60 STATE STREET, BOSTON, MA, 02109, US

(73) Assignee: EM4, Inc., Bedford, MA (US)

(21) Appl. No.: 11/261,261

(22) Filed: Oct. 28, 2005

(51) Int. Cl. G02B 6/36

(52) U.S. Cl. 385/88; 385/92; 385/94

(57) ABSTRACT

An inexpensive TO- or MO-series package is used to house an optical device, such as a laser, by forming an opening in a side of a package, providing an optical fiber within the opening, and coupling the optical device to the fiber. The package is preferably a TO-258 or some other similar metal package.

### BACKGROUND

Many of the commonly used components for fiber optics in the telecom industry have little standardization. Such components, which include diode lasers, 2.5/10 G internally and externally modulated distributed feedback (DFB) lasers, electro-absorption modulated lasers tunable lasers, semiconductor optical amplifiers, LiNbO₃ modulators, and detectors, are typically contained in some form of housing. The housings may be specifically designed for a laser and can be a relatively lower volume and higher cost package than some other types of packages. One common package for a variety of laser modules is a 14-pin butterfly package body style. Because there is no standard, there are many variations of 14-pin butterfly packages on the market. FIGS. 7 and 8 show examples of a common butterfly package and a customized butterfly package, respectively.

Recently, as fiber-based telecommunication technology is approaching the last mile to finally reach consumers from long haul to metro to building, there are increased pressures for cost reduction for the components and subsystems. Multi-source agreements (MSAs) are being formed among leaders of telecom industry, but often there is more than one MSA for one type of product or form factoring. In contrast, the semiconductor industry has more standardization processes and has become a mature industry. A standardization body of the Electronic Industries Alliance trade association is JEDEC (Joint Electron Device Engineering Council). It was created in 1958 to form discrete semiconductor device standards, and was expanded to include integrated circuits in 1970.

### SUMMARY

For high power laser modules used in both telecom, non-telecom, and military applications, the package body has to be able to handle much more power than a conventional 14-pin butterfly package used in telecom applications. The leads for such a package typically cannot handle a current of more than 1 A without ohmic heating leading to meltdown. Although modified 14-pin or 8-pin butterfly packages can address this heating problem, the associated piece part cost on an already non-standardized package body makes it expensive to adopt widely. A variety of custom designed package bodies have been created by a range of manufacturers. These are each unique designs not related to any standard or MSA.

In the embodiments described here, existing JEDEC-defined TO- and MO-series packages (e.g., TO-257, TO-254, TO-258, MO-078, TO-267, and MO-079) are used for high power laser module packaging applications. These JEDEC standard packages were designed to house high power rectifying diodes and power MOSFETs, and can handle very high current and voltage. They have become standard package body styles widely used in semiconductor power module applications, and have undergone continued improvement.

An additional benefit of such packages in fiber optic components is that a copper base material is typically used in TO-series packages, and such a base is useful for reducing the thermal impedance and increasing the thermal conductivity of the entire package. Compared with CuW composite material typically used in a telecom 14-pin butterfly package, cooper not only has a higher thermal conductivity, but it is inexpensive and easy to machine.

By using such standardized packages for fiber optic components, a lower cost packaged device can be made. Other features and advantages will become apparent from the following detailed description, drawings, and claims.

### BRIEF DESCRIPTION OF THE DRAWINGS

FIG. 1 is a perspective view of a TO-258 package for housing an optical device with the lid off.

FIG. 2 is a plan view of an optical device in a metal package.

FIG. 3 is a perspective view of MO-078 package with the lid off.

FIGS. 4-6 are perspective views of alternative TO-258 packages with different types of tabs.

FIGS. 7-8 are perspective views of known 14-pin butterfly packages.

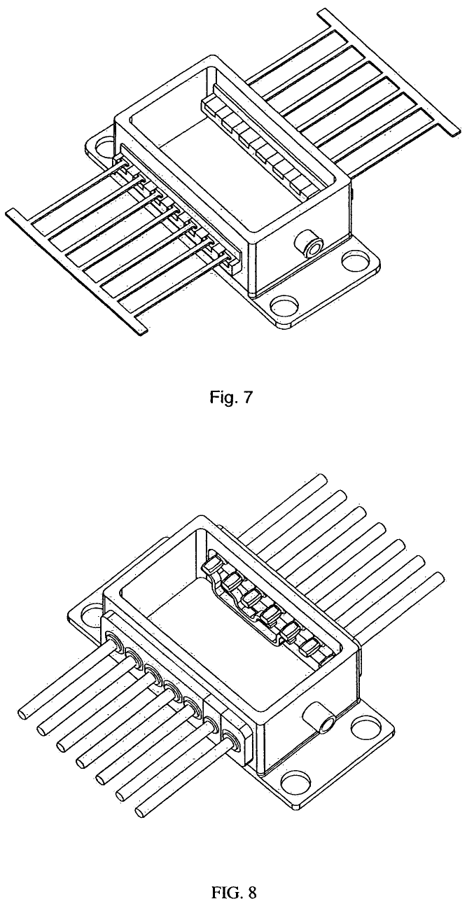

### DETAILED DESCRIPTION

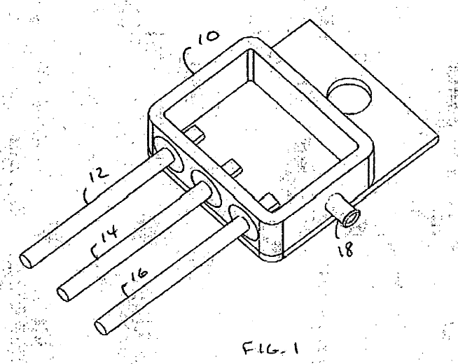

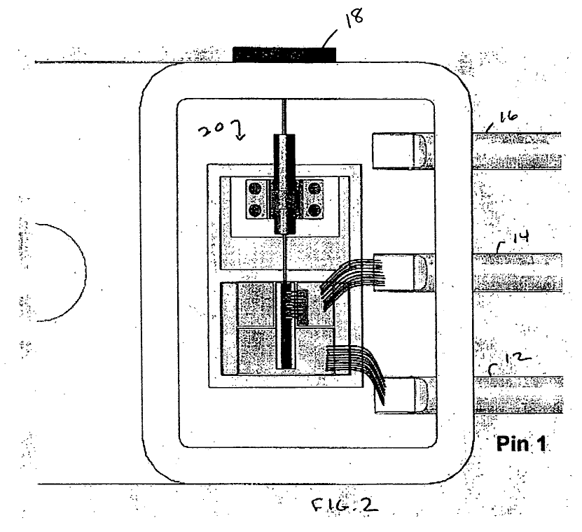

Referring to FIGS. 1 and 2, a fiber optic device, such as a diode laser, is housed in a modified metal package such as a typical JEDEC TO-258 package. In referring to packages, being typical refers to a standard package as it has existed and currently exists, and as such a device may be modified going forward. A TO-258 package (and other similar “TO-” and “MO-” packages) is actually designed for electrical devices, such as high power transistors (e.g., MOSFETs). The TO series packages are generally rectangular and have three leads which would typically be used to connect to three terminals of a transistor (e.g., gate, source, and drain), mounted in the package. The TO-258 is a metal package, approximately 17.5 mm by 13.7 mm, with three leads about 19 mm long. Other similar TO series packages can have sides each with a dimension of about 10-20 mm.

For the application described here, housing 10 has three leads 12, 14, and 16 extending away from one side of the package, and a hole formed, e.g., by drilling, in another side. A fiber ferrule 18 is mounted at the side for holding an optical fiber at the opening and is positioned and aligned in such a way to allow the fiber to couple light from the optical device. Such positioning and aligning is generally known. The optical device is preferably a pump laser 20, but could be a laser diode, and other fiber optic components can be housed in such a package. Laser 20 has an anode coupled to lead 12, and a cathode coupled to lead 14.

In one embodiment, the pump laser is a 7 W, 915 nm, multi-mode laser, formed with a chip-on-submount (COS). The device can operate without a separate cooling device or system. The laser is mounted using a direct bond copper (DBC) ceramic substrate (e.g., BeO or Al₂O₃) to provide thermal management.

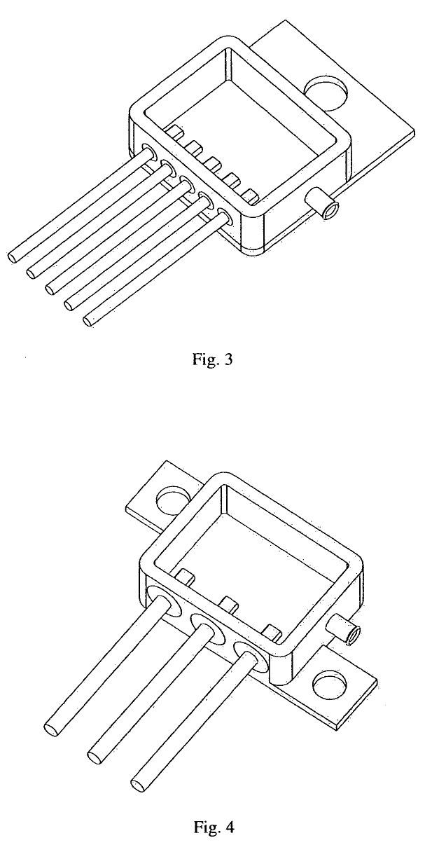

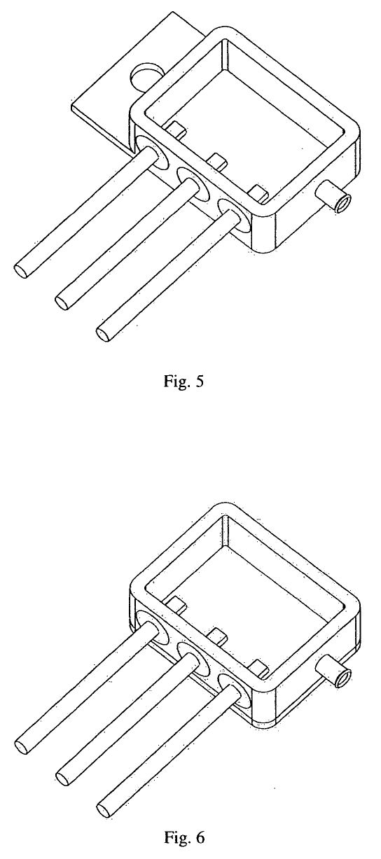

Other metal packages in the TO and Mo series include TO-254, TO-257, TO-259, TO-267, MO-078, and MO-079. These packages are each generally rectangular with about 10-20 mm on the sides in the case of the TO-packages. Referring to FIG. 3, the package can have more than 3 leads, such as the MO-078, which has 5 leads. This MO series package can accommodate more functionality such as a thermistor to monitor chip-on-carrier junction temperature and a back facet photodiode to monitor and diagnose a laser chip optically. Referring to FIGS. 4-6, a TO-258 package can have different styles, including different tab styles, such as a side tab (FIG. 4), a Z-tab (FIG. 5), a tabless design (FIG. 6). FIGS. 4-6 also show the package with the lid off and without a component, but the lid would substantially match the outline at the top and can form a hermetic seal with the rest of the housing.

In each case, these drawings do not depict TO and MO series packages as they would typically be purchased, because they have been modified with a hole and a fiber ferrule for connection to an optical fiber.

Having described embodiments, it should become apparent that modifications can be made without departing from the scope of the invention as defined by the appended claims. For example, while certain devices and materials have been described, it should be apparent that other materials and devices can be used. Some optical devices that can be packaged with the systems and methods described here 600-700 nm diode laser, 780-820 nm diode laser, 900-1070 nm diode laser, 1400-1600 nm diode laser, 2.5/10 G internally and externally modulated distributed feedback (DFB) laser, electro-absorption modulated lasers tunable laser, semiconductor optical amplifiers LiNbO₃ modulator, and LiNbO₃ detector.

What is claimed is:

1. An apparatus comprising:
a MO or TO series package having a wall with an opening for coupling to an optical fiber; and
an optical device housed within the package.

2. The apparatus of claim 1, wherein the optical device includes a pump laser.

3. The apparatus of claim 1, wherein the package is one of a TO-254, TO-257, TO-258, and a TO-267 package.

4. The apparatus of claim 1, wherein the package is one of an MO-078 and MO-079 package.

5. The apparatus of claim 1, wherein the package has a main body and three leads extending away, wherein one of the leads is coupled to a cathode of the optical device and another of the leads is coupled to an anode of the optical device.

6. The apparatus of claim 3, wherein the optical device includes a pump laser.

7. The apparatus of claim 4, wherein the optical device includes a pump laser.

8. The apparatus of claim 1, wherein the optical device includes a pump laser and wherein the package has three leads extending away, wherein one of the leads is electrically coupled to a cathode of the pump laser and another of the leads is electrically coupled to an anode of the pump laser.

9. The apparatus of claim 8, wherein one of the leads is not electrically coupled to the pump laser.

10. The apparatus of claim 1, wherein the optical device includes one of the following: 600-700 nm, diode laser, 780-820 nm diode laser, 900-1070 nm diode laser, 1400-1600 nm diode laser, 2.5/10 G internally and externally modulated distributed feedback (DFB) laser, electro-absorption modulated lasers tunable laser, semiconductor optical amplifiers LiNbO₃ modulator, and LiNbO₃ detector.

11. The apparatus of claim 1, further comprising an optical fiber ferrule at the opening.

12. The apparatus of claim 11, further comprising an optical fiber coupled to the fiber ferrule, the device coupled to provide or receive light through the fiber.

13. A method for making an optical device comprising:
forming an opening in a side wall of a TO or MO series package;
mounting an optical device within the package; and
providing a connector for an optical fiber at the opening.

14. The method of claim 13, wherein the mounting includes mounting a pump laser.

15. The method of claim 14, further comprising coupling an optical fiber to the connector such that light is coupled between the device and the fiber.

16. The method of claim 13, wherein the providing includes providing a fiber ferrule.

17. The method of claim 13, wherein the package is one of a TO-254, TO-257, TO-258, TO-267, MO-078, and MO-079 package.

18. The method of claim 13, wherein the optical device includes one of the following: 600-700 nm, diode laser, 780-820 nm diode laser, 900-1070 nm diode laser, 1400-1600 nm diode laser, 2.5/10 G internally and externally modulated distributed feedback (DFB) laser, electro-absorption modulated lasers tunable laser, semiconductor optical amplifiers LiNbO₃ modulator, and LiNbO₃ detector.

19. The method of claim 13, wherein the optical device includes a pump laser, the package has a first lead electrically coupled to a cathode of the laser and a second lead electrically coupled to an anode of the laser.
